(19) United States
(12) Patent Application Publication
(10) Pub. No.: US 2010/0003567 A1
(43) Pub. Date: Jan. 7, 2010

(54) Fuel cell

(75) Inventor: Satoshi Kadotani, Owariasahi-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/308,509

(22) PCT Filed: Jul. 26, 2007
(86) PCT No.: PCT/IB2007/002126

§ 371 Date: Dec. 17, 2008

(30) Foreign Application Priority Data
Jul. 27, 2006 (JP) 2006-204192

(51) Int. Cl. H01M 8/10; B05D 5/12

(52) U.S. Cl. 429/30; 427/115

(57) ABSTRACT

A fuel cell includes an electrolyte membrane, a cathode electrode layer disposed at a surface of the electrolyte membrane, and an anode electrode layer disposed at a surface of the electrolyte membrane opposite to a surface facing the cathode electrode layer. At least one of the cathode electrode layer and the anode electrode layer includes a first catalyst layer disposed at an interface with the electrolyte membrane, and a second catalyst layer disposed at a surface of the first catalyst layer opposite to a surface facing the electrolyte membrane. The first catalyst layer is configured to contain a catalyst not supported on a carrier and not to contain a catalyst supported on a carrier. The second catalyst layer is configured to contain a catalyst supported on a carrier.

### BACKGROUND OF THE INVENTION

1. Field of the Invention

The present invention relates to a technique to suppress degradation in performance of a fuel cell.

2. Description of the Related Art

Fuel cells, for example polymer electrolyte fuel cells, have a construction in which MEAs (membrane electrode assemblies) and separators are laminated alternately, each MEA being manufactured by interposing an electrolyte membrane between a cathode electrode and an anode electrode (which may hereinafter be collectively referred to simply as “electrodes”).

Oxidant gas containing oxygen is supplied via the separator to the cathode electrode, to be used in a reaction represented by the formula (1) below. On the other hand, fuel gas containing hydrogen is supplied via the separator to the anode electrode, to be used in a reaction represented by the formula (2) below. Fuel cells convert chemical energy of such substances directly into electrical energy according to these reactions.

Cathode electrode reaction: 2H⁺+2e⁻+(½)O₂→H₂O (1)

Anode electrode reaction: H₂→2H⁺+2e⁻ (2)

The electrodes contain a catalyst in order that the above reactions of the oxidant gas and the fuel gas (which may hereinafter be collectively referred to as “reaction gas”) at the electrodes proceed efficiently. An example of the catalyst is platinum supported on carbon as a carrier.

One factor that may degrade the performance of a fuel cell is oxidation (corrosion) of the catalyst carrier contained in the electrodes. For example, if carbon as a carrier is oxidized due to the influence of electric potential, platinum particles supported on the carbon are aggregated together, or sintered, to reduce the surface area and hence catalytic action of the platinum, and the amount of the carbon itself reduces to reduce its electron conductivity, which consequently may degrade the performance of the fuel cell.

The Japanese patent application publication No. JP-A-2005-294264 discloses a technique to reduce such degradation in performance of a fuel cell by using a mixture of platinum black and platinum supported on carbon as a catalyst, for example.

According to the above technique, however, the platinum supported on carbon is disposed in the vicinity of an interface between an electrode and an electrolyte membrane where carbon tends to be oxidized, and oxidized carbon may degrade the performance of the fuel cell.

Such a problem may occur not only in the case where platinum supported on carbon is used as a catalyst, but also in the case where other carrier-carried catalysts are used.

### SUMMARY OF THE INVENTION

The present invention provides a technique to suppress degradation in performance of a fuel cell.

A first aspect of the present invention is directed to a fuel cell including an electrolyte membrane, a cathode electrode layer disposed at a surface of the electrolyte membrane, and an anode electrode layer disposed at a surface of the electrolyte membrane opposite to a surface facing the cathode electrode layer. The fuel cell is characterized in that at least one of the cathode electrode layer and the anode electrode layer includes: a first catalyst layer that is disposed on the surface of the electrolyte membrane; and a second catalyst layer that is disposed over the first catalyst layer, wherein the first catalyst layer contains a catalyst that is not supported on a carrier, and does not contain a catalyst that is supported on a carrier, and the second catalyst layer contains a catalyst that is supported on a carrier.

According to the above aspect, at least one of the cathode electrode layer and the anode electrode layer of the fuel cell includes a first catalyst layer disposed at an interface with the electrolyte membrane, and a second catalyst layer disposed at a surface of the first catalyst layer opposite to a surface facing the electrolyte membrane. In addition, the first catalyst layer is configured to contain a catalyst not supported on a carrier and not to contain a catalyst supported on a carrier. Thus, oxidation of a carrier in the electrode layers, and hence degradation in performance of the fuel cell, can be suppressed.

In the above aspect, the catalyst not supported on a carrier may be metal containing platinum.

With this construction, oxidation of a carrier in the electrode layers can be suppressed, the proton conductivity in the first layer can be improved, and thus improvement in performance of the fuel cell can be expected.

In the above aspect, the carrier may contain carbon.

With this construction, oxidation of carbon in the electrode layers, and hence degradation in performance of the fuel cell, can be suppressed.

In the above aspect, the cathode electrode layer may include the first catalyst layer and the second catalyst layer, and the first catalyst layer may be omitted from the anode electrode layer.

With this construction, oxidation of a carrier in the cathode electrode layer where a carrier is more likely to be oxidized and hence degradation in performance of the fuel cell can be suppressed, while the anode electrode layer where a carrier is less likely to be oxidized can be made simple and thus improvement in manufacturing efficiency can be expected.

A second aspect of the present invention is directed to a method for manufacturing a fuel cell including an electrolyte membrane, a cathode electrode layer disposed at a surface of the electrolyte membrane, and an anode electrode layer disposed at a surface of the electrolyte membrane opposite to a surface facing the cathode electrode layer. The method for manufacturing a fuel cell is characterized by including: forming a first catalyst layer on a surface of the electrolyte membrane that faces at least one of the cathode electrode layer and the anode electrode layer, wherein the first catalyst layer contains a catalyst that is not supported on a carrier, and does not contain a catalyst that is supported on a carrier; and forming a second catalyst layer over the first catalyst layer, wherein the second catalyst layer contains a catalyst that is supported on a carrier.

The present invention can be implemented in various forms. For example, the present invention can be implemented in forms such as a fuel cell and a method for manufacturing the same, an electrode for a fuel cell and a method for manufacturing the same, a catalyst layer for a fuel cell and a method for manufacturing the same, and an MEA for a fuel cell and a method for manufacturing the same.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is an explanatory view schematically showing the construction of a fuel cell according to an example of the present invention;

FIG. 2 is an explanatory view schematically showing the cross section of a cathode side catalyst layer of FIG. 1;

FIG. 3 is a flowchart showing a method for manufacturing an MEA according to the example;

FIG. 4 is an explanatory chart showing the results of a performance evaluation test on the MEA for use in the fuel cell according to the example; and

FIG. 5 is an explanatory chart showing the results of a performance evaluation test on the MEA for use in the fuel cell according to the example.

### DETAILED DESCRIPTION OF THE EXAMPLE EMBODIMENTS

A description will now be made of an embodiment of the present invention based on examples in the following order: A. Example, B. Performance Evaluation, and C. Modified Examples.

### A. Example

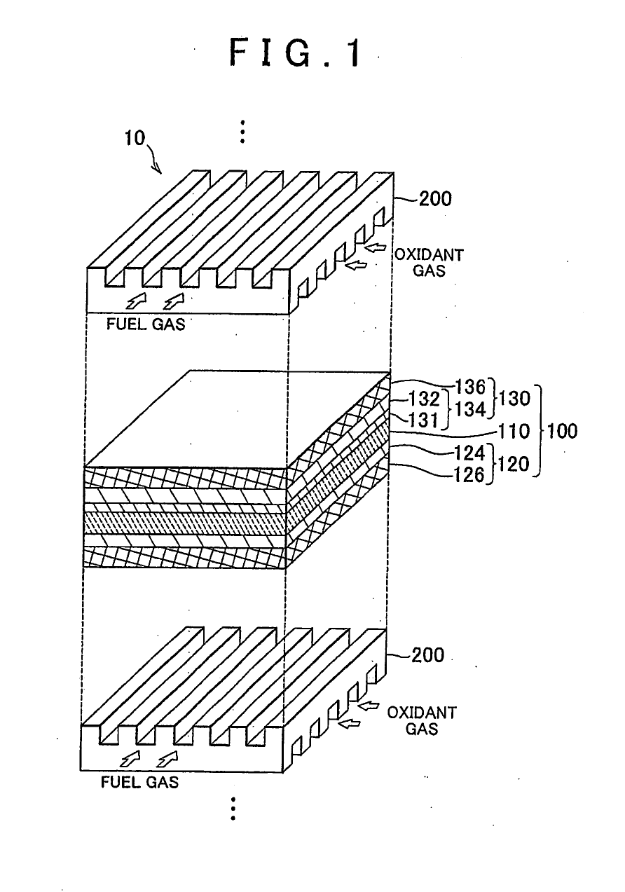

FIG. 1 is an explanatory view schematically showing the construction of a fuel cell 10 according to an example. The fuel cell 10 is a polymer electrolyte fuel cell, which is relatively small in size and excellent in power generation efficiency. The fuel cell 10 has a stack structure in which a plurality of MEAs (membrane electrode assemblies) 100 each being sandwiched between separators 200 are laminated. In order to make it easy to understand the construction of the fuel cell 10, FIG. 1 shows an MEA 100 and separators 200 before being laminated together.

Each MEA 100 has an electrolyte membrane 110, an anode electrode 120 disposed on one surface of the electrolyte membrane 110, and a cathode electrode 130 disposed on the other surface of the electrolyte membrane 110.

The electrolyte membrane 110 is an ion exchange membrane formed of a polymeric material such as fluorine-based resins (for example, NAFION manufactured by Dupont), and has good proton conductivity in wet conditions.

The anode electrode 120 is where an anode electrode reaction proceeds, and includes an anode catalyst layer 124 disposed adjacent to the electrolyte membrane 110 and an anode side diffusion layer 126 disposed adjacent to the separator 200.

The cathode electrode 130 is where a cathode electrode reaction proceeds, and includes a cathode catalyst layer 134 disposed adjacent to the electrolyte membrane 110 and a cathode diffusion layer 136 disposed adjacent to the separator 200. The cathode catalyst layer 134 includes a first cathode catalyst layer 131 disposed at an interface between the cathode catalyst layer 134 and the electrolyte membrane 110 and a second cathode catalyst layer 132 disposed between the cathode first catalyst layer 131 and the cathode diffusion layer 136.

In the description below, the anode electrode 120 and the cathode electrode 130 may be collectively referred to simply as “electrodes.” Likewise, the anode catalyst layer 124 and the cathode catalyst layer 134 may be collectively referred to simply as “catalyst layers,” and the anode diffusion layer 126 and the cathode diffusion layer 136 maybe collectively referred to simply as “diffusion layers.”

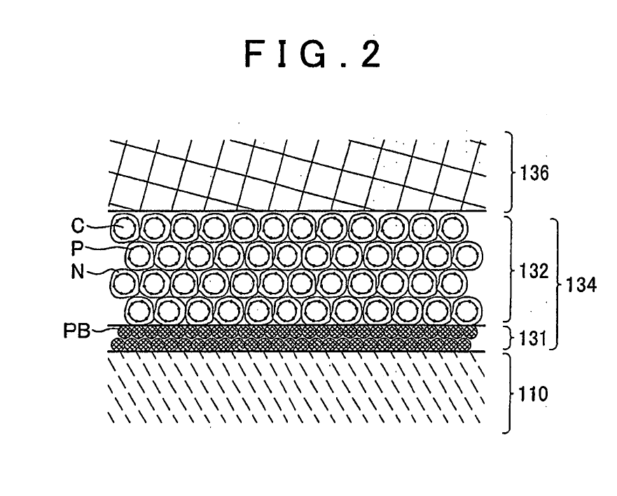

FIG. 2 is an explanatory view schematically showing the cross section of the cathode catalyst layer 134. As discussed above, the cathode catalyst layer 134 includes the first cathode catalyst layer 131 and the second cathode catalyst layer 132. The second cathode catalyst layer 132 contains a catalyst supported on a carrier. That is, the second cathode catalyst layer 132 is a mixed layer of platinum (P) supported on a carbon (C) as a carrier and an electrolyte resin (N), as shown in FIG. 2. Minute pores that allow the passage of reaction gas and generated water are formed in the second cathode catalyst layer 132.

On the other hand, the first cathode catalyst layer 131 contains a catalyst not supported on a carrier. That is, the first cathode catalyst layer 131 is constituted as a mixed layer of platinum black (PB) and an electrolyte resin, as shown in FIG. 2. The first cathode catalyst layer 131 does not contain a catalyst supported on a carrier, such as, for example, platinum supported on carbon. Platinum black has proton conductivity. Minute pores that allow the passage of reaction gas and generated water are also formed in the first cathode catalyst layer 131.

Each separator 200 (FIG. 1) is formed of a material that is dense and hence impermeable to gas and that has electrical conductivity, for example compression-molded dense carbon, metal, and conductive resin. One surface of one separator 200 is in contact with the anode diffusion layer 126 of one MEA 100, and the other surface of the separator 200 is in contact with the cathode diffusion layer 136 of another MEA 100. Grooves are formed in both surfaces of the separator 200. After components of the fuel cell 10 are laminated together, fuel gas flow paths are formed between the grooves formed in the surface in contact with the anode diffusion layer 126 and the anode diffusion layer 126. Also, oxidant gas flow paths are formed between the grooves formed in the surface in contact with the cathode diffusion layer 136 and the cathode diffusion layer 136. The separator 200 may have a coolant flow path inside.

Although not shown in FIG. 1, a fuel gas supply manifold, a fuel gas exhaust manifold, an oxidant gas supply manifold, and an oxidant gas exhaust manifold are provided in the fuel cell 10, and penetrate through the fuel cell stack in the laminating direction (vertical direction of FIG. 1). Fuel gas supplied to the fuel cell stack is distributed via the fuel gas supply manifold to the fuel gas flow paths, to be used in an electrochemical reaction at the MEA 100. The fuel gas unused is exhausted to the outside via the fuel gas exhaust manifold. Oxidant gas supplied to the fuel cell stack is distributed via the oxidant gas supply manifold to the oxidant gas flow paths, to be used in an electrochemical reaction at the MEA 100. The oxidant gas unused is exhausted to the outside via the oxidant gas exhaust manifold. An example of the fuel gas is hydrogen gas. An example of the oxidant gas is air.

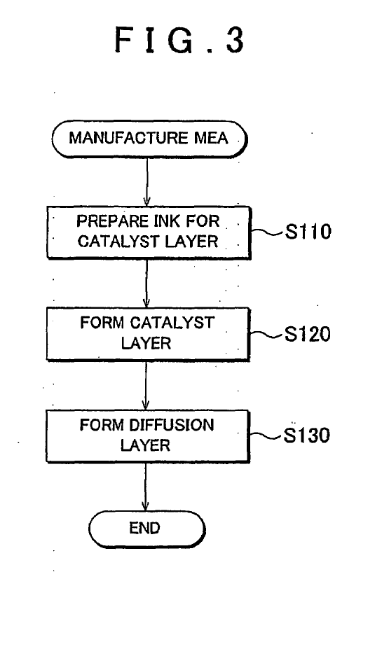

FIG. 3 is a flowchart showing a method for manufacturing the MEA 100 for use in the fuel cell 10 according to this example. First, ink for the catalyst layers is prepared (step S110). In this example, inks of different compositions are prepared to form the first cathode catalyst layer 131, the second cathode catalyst layer 132, and the anode catalyst layer 124.

Table 1 shows the composition of ink for the first cathode catalyst layer 131 in this example. In this example, materials shown in Table 1 (platinum black, an electrolyte, water and ethanol) are blended, and stirred with a disper mill for 4 hours, to prepare the ink for the first cathode catalyst layer 131.

TABLE 1
Ink Composition Containing Platinum Black

| | Composition |
|---|---|
| Materials | (wt %) |
| Platinum black | 1.0 |
| Electrolyte | 0.15 |
| Water | 10.0 |
| Ethanol | 10.0 |

Table 2 shows the composition of ink for the second cathode catalyst layer 132 in this example. In this example, materials shown in Table 2 (platinum-carrying carbon, an electrolyte, water, and ethanol) are blended, and dispersed using an ultrasonic homogenizer for 20 minutes, to prepare the ink for the second cathode catalyst layer 132. The amount of platinum supported on the carbon is 50 wt % (weight percent).

TABLE 2
Ink Composition Containing Platinum-Carrying Carbon (Cathode)

| | Composition |
|---|---|
| Materials | (wt %) |
| 50% platinum-carrying carbon | 1.0 |
| Electrolyte | 0.4 |
| Water | 6.0 |
| Ethanol | 8.0 |

Table 3 shows the composition of ink for the anode catalyst layer 124 in this example. In this example, materials shown in Table 3 (platinum-carrying carbon, an electrolyte, water, and ethanol) are blended, and dispersed using an ultrasonic homogenizer for 20 minutes, to prepare the ink for the anode catalyst layer 124. The amount of platinum supported on the carbon is 50 wt % (weight percent).

TABLE 3
Ink Composition Containing Platinum-Carrying Carbon (Anode)

| | Composition |
|---|---|
| Materials | (wt %) |
| 50% platinum-carrying carbon | 1.0 |
| Electrolyte | 0.5 |
| Water | 6.0 |
| Ethanol | 8.0 |

Then, the catalyst layers are formed (step S120). In this example, the catalyst layers are formed using a spray applicator. First, the ink prepared for the first cathode catalyst layer 131 is sprayed onto a surface of the electrolyte membrane 110 on the cathode side in an amount of 0.1 mg of platinum per 1 square centimeter. Then, the ink prepared for the second cathode catalyst layer 132 is sprayed onto the surface to which the first cathode catalyst layer 131 has been applied in an amount of 0.3 mg of platinum per 1 square centimeter. Thus, the total amount of the platinum in the cathode catalyst layer 134 is 0.4 mg per 1 square centimeter.

Subsequently, the ink prepared for the anode catalyst layer 124 is sprayed onto a surface of the electrolyte membrane 110 on the anode side in an amount of 0.2 mg of platinum per 1 square centimeter.

Then, the diffusion layers are formed (step S130). In this example, the diffusion layers are formed by applying water repellent paste to diffusion layer sheets in advance, and joining the diffusion layer sheets by hot pressing (140° C., 4 MPa) to the electrolyte membrane 110 on which the catalyst layers have been formed. The MEA 100 having the described construction using FIGS. 1 and 2 is manufactured in the above processes.

As described above, in the fuel cell 10 according to this example, the cathode catalyst layer 134 in the MEA 100 includes a first cathode catalyst layer 131 disposed at an interface between the cathode catalyst layer 134 and the electrolyte membrane 110 and a second cathode catalyst layer 132 disposed at an interface between the cathode catalyst layer 134 and the cathode diffusion layer 136. The first cathode catalyst layer 131 contains a catalyst not supported on a carrier (platinum black) and does not contain a catalyst carried by a carrier such as platinum carried by carbon. Thus, oxidation of carbon is suppressed in the vicinity of an interface between the cathode catalyst layer 134 with the electrolyte membrane 110 where carbon tends to be oxidized due to a potential. As a result, with the fuel cell 10 according to this example, it is possible to suppress oxidation of carbon in the cathode catalyst layer 134 effectively and hence suppress degradation in performance of the fuel cell.

Also, in the fuel cell 10 according to this example, the cathode catalyst layer 134 has the first cathode catalyst layer 131, which does not contain carbon as a carrier, and can be therefore made thin compared to a cathode catalyst layer that uniformly contains carbon as a carrier. Thus, the concentration polarization in the cathode catalyst layer 134 is reduced. As a result, with the fuel cell 10 according to this example, improvement in performance of the fuel cell can be expected.

In addition, in the fuel cell 10 according to this example, the first cathode catalyst layer 131 containing platinum black having proton conductivity is disposed in the vicinity of an interface of the cathode catalyst layer 134 with the electrolyte membrane 110. Thus, the proton conductivity in the cathode catalyst layer 134 can be further improved, and hence improvement in performance of the fuel cell can be expected.

In view of what has been discussed above, with the fuel cell 10 according to this example, cost reduction can be expected by reducing the amount of the platinum used to form the cathode catalyst layer 134, while maintaining the performance of the fuel cell.

When a cathode catalyst layer includes only a layer containing platinum black and not including a layer containing platinum supported on carbon, the cathode catalyst layer is made extremely thin to unfavorably reduce the gas diffusion properties, and the water drainage properties are reduced due to the influence of the hydrophilic properties of the platinum black, which consequently may degrade the performance of the fuel cell. In the fuel cell 10 according to this example, the cathode catalyst layer 134 is made up of the thin first cathode catalyst layer 131 containing platinum black and the second cathode catalyst layer 132 containing platinum supported on carbon, thereby suppressing reduction in gas diffusion properties and water drainage properties.

### B. Performance Evaluation

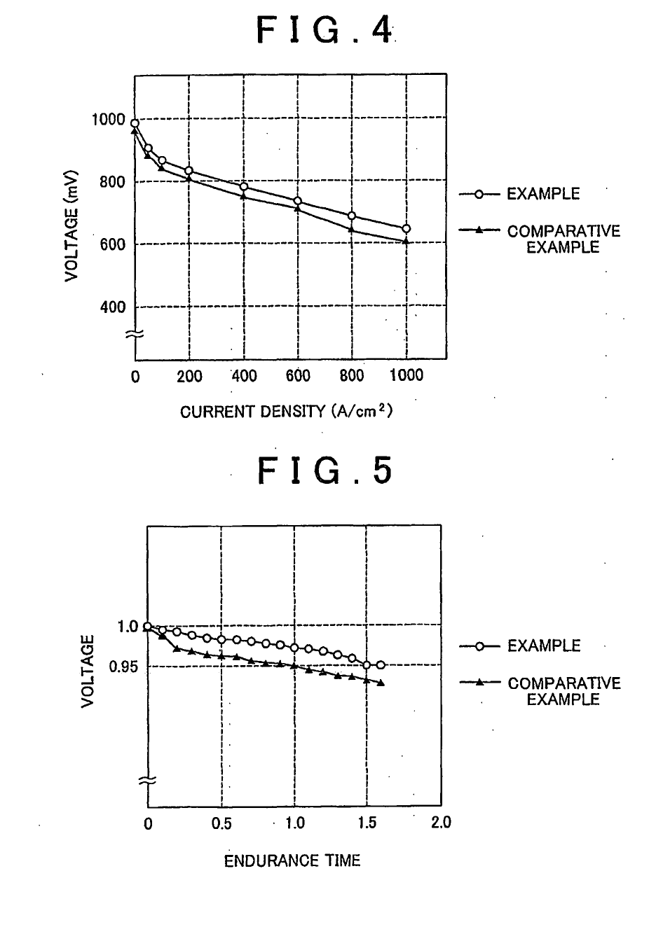

FIGS. 4 and 5 are explanatory charts showing the results of performance evaluation tests on the MEA 100 for use in the fuel cell 10 according to this example. In the performance evaluation tests, an MEA according to a comparative example was used along with the MEA 100 according to this example. The difference between the MEA according to the comparative example and the MEA 100 according to this example is merely the construction of the cathode catalyst layer. The cathode catalyst layer in the MEA according to the comparative example has only a mixed layer of platinum supported on carbon as a carrier and an electrolyte resin such as the second cathode catalyst layer 132 (FIG. 2) in the example. That is, the cathode catalyst layer in the MEA according to the comparative example does not include a layer in which the catalyst is not supported on a carrier, such as the cathode side first catalyst layer 131 (FIG. 2) in the example.

In order to manufacture the MEA according to the comparative example constructed as described above, the same ink as that for the second cathode catalyst layer 132 (Table 2) in the example is sprayed onto the surface of an electrolyte membrane on the cathode side in an amount of 0.4 mg of platinum per 1 square centimeter to form a cathode catalyst layer. In this way, there can be formed a cathode catalyst layer containing platinum in the same amount as and having a different construction from the cathode catalyst layer 134 according to the example. The cathode catalyst layer 134 according to the example is thinner than the cathode catalyst layer according to the comparative example, because the former has the first cathode catalyst layer 131, which does not contain carbon as a carrier.

Subsequently, an anode catalyst layer and diffusion layers are formed in the same way as the MEA 100 according to the example. That is, the same ink as that used for the anode catalyst layer 124 (Table 3) in the example is sprayed onto the surface of the electrolyte membrane on the anode side in an amount of 0.2 mg of platinum per 1 square centimeter to form an anode catalyst layer. Then, diffusion layer are joined by hot pressing to form diffusion layers.

FIG. 4 shows the evaluation results of I-V performance. As shown in FIG. 4, the MEA 100 according to this example exhibited improved I-V performance over the MEA according to the comparative example. One possible factor of the improved I-V performance is that in the MEA 100 according to the example, the cathode catalyst layer 134 is appropriately thin as discussed above so that the concentration polarization in the cathode catalyst layer 134 is reduced and the gas diffusion properties are further improved. Another possible factor is that in the MEA 100 according to the example, the first cathode catalyst layer 131 containing platinum black having proton conductivity is disposed in the vicinity of an interface of the cathode catalyst layer 134 with the electrolyte membrane 110 so that the proton conductivity in the cathode catalyst layer 134 is further improved.

FIG. 5 shows the evaluation results of endurance performance. In FIG. 5, the voltage value at a current density of 1.0 A/cm² is defined as 1.0 for both the example and the comparative example. Also, the endurance time (operation time) at the time when the voltage value of the MEA according to the comparative example reduced by 5% is defined as 1.0. As shown in FIG. 5, the endurance time at the time when the voltage value of the MEA according to the example reduced by 5% is about 1.5 times that of the comparative example, and thus the MEA 100 according to the example exhibits improved endurance performance over the MEA according to the comparative example. A possible factor of the improved endurance performance is that in the MEA 100 according to the example, the first cathode catalyst layer 131 disposed at an interface of the cathode catalyst layer 134 with the electrolyte membrane 110 does not contain carbon as a carrier so that adverse effects of carbon oxidation on the endurance performance are suppressed. When carbon as a carrier is disposed in the vicinity of an interface of the cathode catalyst layer with the electrolyte membrane, as in the comparative example, carbon tends to be oxidized due to the influence of a potential. In such a case, platinum particles supported on the carbon are aggregated together, or sintered, which reduces the surface area and hence catalytic action of the platinum, and the amount of the carbon itself is reduced, thereby reducing its electron conductivity, which consequently tends to degrade the performance of the fuel cell.

### C. Modifications

The present invention is not limited to the above embodiment and examples, and various modifications may be made without departing from the scope thereof. Examples of the modifications are described below.

### C-1. Modification 1

The construction of the fuel cell 10 according to the example is merely an example, and other constructions are also possible. For example, the first cathode catalyst layer 131 may be otherwise arbitrarily constructed as long as it does not contain a catalyst supported on a carrier, rather than being a mixed layer of platinum black and an electrolyte resin as in the above example. To be specific, the first cathode catalyst layer 131 may be a single layer of platinum black. Alternatively, the first cathode catalyst layer 131 may be configured to contain platinum alloys such as platinum iron and platinum cobalt and other arbitrary catalyst components, instead of or in addition to platinum black.

Also, the second cathode catalyst layer 132 may be otherwise arbitrarily constructed as long as it is configured to contain a catalyst supported on a carrier. For example, the second cathode catalyst layer 132 may be configured to contain an arbitrary catalyst carried on a carrier, instead of platinum supported on carbon.

The compositions of inks for catalyst layers shown in Tables 1 to 3 are merely examples, and other compositions are also possible.

Instead of or in addition to the cathode catalyst layer 134, the anode catalyst layer 124 may contain a first catalyst layer disposed at an interface with the electrolyte membrane 110 and a second catalyst layer disposed at an interface with the anode diffusion layer 126. Also in this case, other arbitrary constructions are also possible as long as the first catalyst layer does not contain a catalyst supported on a carrier and not to contain a catalyst carried by a carrier and the second catalyst layer is configured to contain a catalyst supported on a carrier.

### C-2. Modification 2

The method for manufacturing the fuel cell 10 according to the example is merely an example, and other manufacturing methods are also possible. For example, the catalyst layers may be formed by other methods such as blading and powder coating, rather than spaying as in the above example.

1-11. (canceled)

12. A fuel cell comprising:
an electrolyte membrane;
a cathode electrode layer disposed at a surface of the electrolyte membrane; and
an anode electrode layer disposed at a surface of the electrolyte membrane opposite the surface that faces the cathode electrode layer,
a first catalyst layer that is disposed on a surface of the electrolyte membrane that faces at least one of the cathode electrode layer and the anode electrode layer; and
a second catalyst layer that is disposed over the first catalyst layer, wherein:
the first catalyst layer contains a catalyst that is not supported on a carrier, and does not contain a catalyst that is supported on a carrier; and
the second catalyst layer contains a catalyst that is supported on a carrier.

13. The fuel cell according to claim 12, wherein the catalyst not supported on a carrier is metal containing platinum.

14. The fuel cell according to claim 12, wherein the carrier contains carbon.

15. The fuel cell according to claim 12, wherein the cathode electrode layer includes the first catalyst layer and the second catalyst layer, and the anode electrode layer does not include the first catalyst layer.

16. The fuel cell according to claim 13, wherein the metal containing platinum is at least one selected from the group consisting of platinum black, platinum iron and platinum cobalt.

17. The fuel cell according to claim 12, wherein:
the cathode electrode layer comprises a cathode diffusion layer disposed over the cathode catalyst layer; and
the anode electrode layer comprises an anode diffusion layer disposed over the anode catalyst layer.

18. The fuel cell according to claim 17, further comprising:
a cathode side separator disposed at a surface of the cathode electrode layer opposite to a surface facing the electrolyte membrane; and
an anode side separator disposed at a surface of the anode electrode layer opposite to a surface facing the electrolyte membrane.

19. The fuel cell according to claim 18, wherein:
an oxidant gas flow path allowing communication of oxidant gas is formed in a surface of the cathode side separator facing the cathode side diffusion layer; and
a fuel gas flow path allowing communication of fuel gas is formed in a surface of the cathode side separator opposite to a surface facing the cathode side diffusion layer.

20. The fuel cell according to claim 18, wherein:
a fuel gas flow path allowing communication of fuel gas is formed in a surface of the anode side separator facing the anode diffusion layer; and
an oxidant gas flow path allowing communication of oxidant gas is formed in a surface of the anode side separator opposite to a surface facing the anode diffusion layer.

21. A method for manufacturing a fuel cell including an electrolyte membrane; a cathode electrode layer disposed at a surface of the electrolyte membrane; and an anode electrode layer disposed at a surface of the electrolyte membrane opposite the surface that faces the cathode electrode layer, the method comprising:
forming a first catalyst layer on a surface of the electrolyte membrane that faces at least one of the cathode electrode layer and the anode electrode layer, wherein the first catalyst layer contains a catalyst that is not supported on a carrier, and does not contain a catalyst that is supported on a carrier; and
forming a second catalyst layer over the first catalyst layer, wherein the second catalyst layer contains a catalyst that is supported on a carrier.
